(19) United States
(12) Patent Application Publication
(10) Pub. No.: US 2011/0302677 A1
(43) Pub. Date: Dec. 8, 2011

(54) DETECTION AND CHARACTERIZATION OF LASER-INDUCED HEAT AFFECTED ZONES ON POLYMER BASED DEVICES

(75) Inventors: Kamal RAMZIPOOR, Fremont, CA (US); Yiwen TANG, San Jose, CA (US)

(73) Assignee: Amaranth Medical Pte, Singapore (SG)

(21) Appl. No.: 13/152,704

(22) Filed: Jun. 3, 2011

Related U.S. Application Data
(60) Provisional application No. 61/351,485, filed on Jun. 4, 2010.

(51) Int. Cl. G01Q 60/24

(52) U.S. Cl. 850/33

(57) ABSTRACT

Detection and characterization of laser-induced heat affected zones on polymer based devices, such as polymeric stents, are described where Nano Thermal Analysis may be used with atomic force microscopy to obtain the thermal behavior of materials with a spatial resolution of under, e.g., 100 nm. Heat may be applied locally to the measured polymeric stem via a probe tip and the resulting thermal-mechanical response can be measured.

### CROSS-REFERENCE TO RELATED APPLICATIONS

This application claims benefit of priority to U.S. Provisional Patent Application No. 61/351,485 filed Jun. 4, 2010, the contents of which is incorporated herein by reference in its entirety.

### FIELD OF THE INVENTION

The present invention relates generally to methods and apparatus for detecting and characterizing areas on medical devices which are affected by heat. More particularly, the present invention relates generally to methods and apparatus for detecting and characterizing heated zones on polymer based devices, such as stents, which are affected by laser-induced instruments.

### BACKGROUND OF THE INVENTION

Femtosecond laser machining process have been used in fabrication of bioabsorbable polymeric devices, especially implantable stents, with great success. It is generally assumed that the ultra short pulse of these lasers have a negligible effect on polymer properties; however, the actual results depends highly on the nature of the polymer, dimensions of the machined device, geometry of the device, as well as operating parameters of the laser.

In many cases, the heat induced from femtosecond laser machining can diffuse into the cutting area and leave a heat affected zone. For micro-sized devices, this affected zone can be significant such that the performance of the device is influenced.

The depth of this heat affected zone can be related to the amount of energy used by the laser in cutting through the area. Therefore, on a polymeric stent the heat affected zone may be deeper in those segments of the geometry having acute angles (as the laser speed may slow down in these areas and may therefore disperse more energy) than in those segments to be machined having relatively straight areas.

However, it is very difficult to detect any differences in the polymer property in such a small zone. The use of Nano Thermal Analysis (NTA) can be one method to detect and characterize the effects of laser energy on polymer based micro-sized devices.

### SUMMARY OF THE INVENTION

Nano Thermal Analysis (NTA) is a localized thermal analysis technique that may be used with the high spatial resolution imaging capability of atomic force microscopy (AFM) to obtain the thermal behavior of materials with a spatial resolution of under, e.g., 100 nm. The AFM enables a surface to be visualized at nanoscale resolution while applying heat locally via a probe tip and measuring the thermal-mechanical response using NTA.

A poly-L-lactide (PLLA) based polymeric stent was cut using a 2 kHz laser and the cross section of an area of the polymeric stent having acute angles (e.g., W link), relatively less angulations (e.g., V link), and relatively straight areas (e.g., bar arm) were micro-toned followed by measurement of the nano-area thermal property using NTA (manufactured by Anasys Instruments, Santa Barbara). The results indicate thermal transitions which affect the material properties can be detected along the stent sample.

### BRIEF DESCRIPTION OF THE DRAWINGS

FIG. 1 shows an example of Nano Thermal Analysis utilizing atomic force microscopy on a polymeric stent sample.

FIG. 2 shows a graph illustrating the thermal transitions measured over a cross section of a W link portion of a polymeric stent.

FIG. 3 shows a graph illustrating the thermal properties from the first three measurements taken at 10 μm increments from the edge of a polymeric stent sample.

FIG. 4 shows a graph illustrating the thermal transitions for each detection point across a line along the cross section of a bar arm portion of a polymeric stent sample.

### DETAILED DESCRIPTION OF THE INVENTION

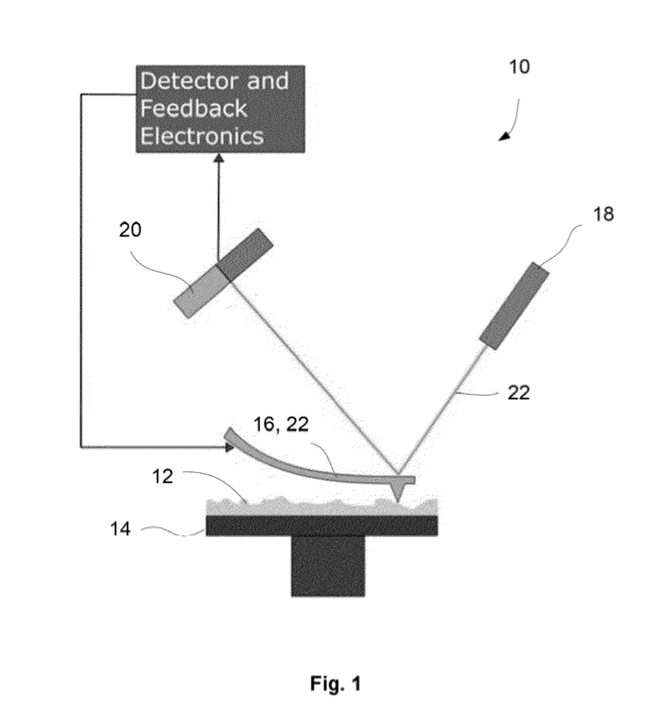

The Nano Thermal Analysis (NTA) is a localized thermal analysis technique that combines the high spatial resolution imaging capability of atomic force microscopy (AFM) and the ability to obtain the thermal behavior of materials with a spatial resolution of under, e.g., 100 nm. As shown in assembly 10 of FIG. 1, the conventional AFM tip may be replaced by a special probe 16 that has an embedded miniature heater 22 and may be controlled by specially designed NTA hardware and software. The AFM utilizes a laser 18 which emits a beam of laser energy 22 upon the probe 16 as the probe 16 is contacted against the sample. The laser energy 22 is reflected by the probe 16 as it moves in response to the measured sample 12, e.g., a polymeric stent, and the reflected light is detected by a photodiode detector 20. The measured light enables a surface to be visualized at nanoscale resolution with its routine imaging modes which may allow the user to select the spatial location at which to investigate the thermal properties of the surface. The user may then obtain this information by applying heat locally via the probe tip 16 and measuring the thermal-mechanical response.

A poly-L-lactide (PLLA) based polymeric stent was cut using a 2 kHz laser. The cross section of an area of the polymeric stent having acute angles (e.g., W link), relatively less angulations (e.g., V link), and relatively straight areas (e.g., bar arm) were micro-toned followed by measurement of the nano-area thermal property using NTA (manufactured by Anasys Instruments, Santa Barbara).

From one edge of the cross section to the other end, the probe 16 was applied onto the surface and heat was transferred to the material 12 and the response was recorded while the glass transition temperature, T_{g}, and/or melting temperature, Tₘ, of the local area was recorded. The probe 16 was then moved about 10 μm away to take another measurement. This was repeated in a straight line to the other edge of the cross section.

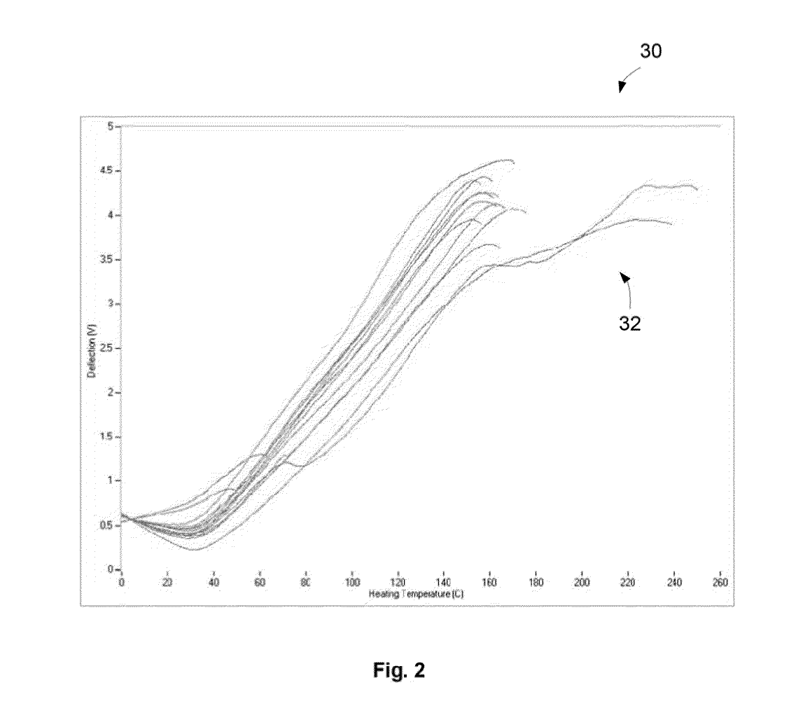

A set of thermal transitions were recorded as shown in FIG. 2, which illustrates a chart 30 of the heating temperature (C) versus deflection measured by the probe 16 showing the thermal transitions for each detection points across a line on the cross section on a W link portion of the stent. From these lines, it can be seen that several lines 32 are showing different patterns.

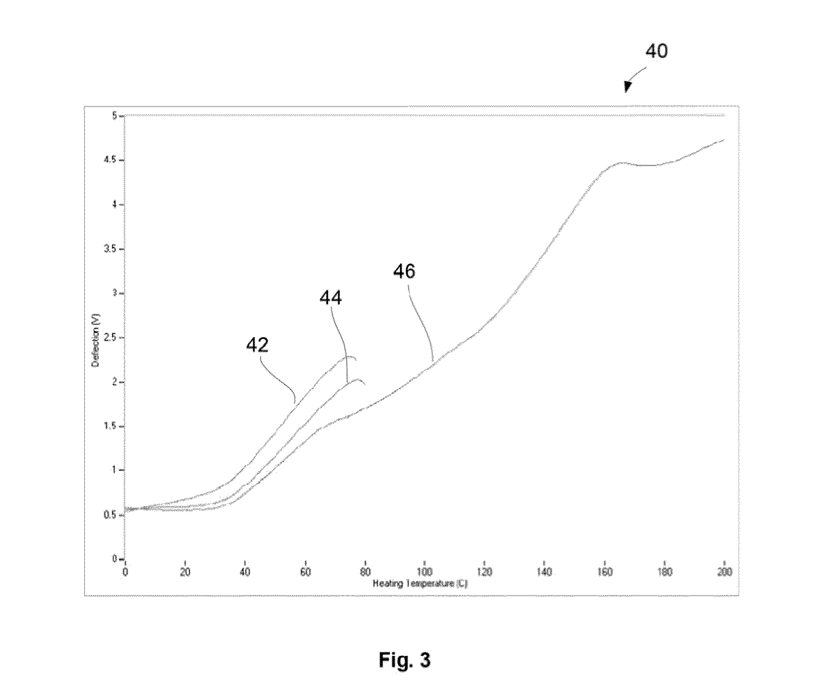

As shown in FIG. 3, which illustrates a chart of the thermal property of the first three measurements taken from a first edge of the stent sample 12, these sampled measurements were taken at 10 μm increments from a first edge. As illustrated, the first measurement 42 was taken from the edge of the sample 12 and the second measurement 44 was taken at a distance of 10 μm from the point of the first measurement 42. The third measurement 46 was then taken at another 10 μm from the point of the second measurement 44. As the distance between each measured spot was 10 μm, the sample 12 beyond 20 μm from the laser-cut edge was indicated as having different properties as compared to the remainder of the sample. Based on the understanding of the PLLA material and the effect of laser energy on the material, the heat affected zone of this cross section is about 20 μm.

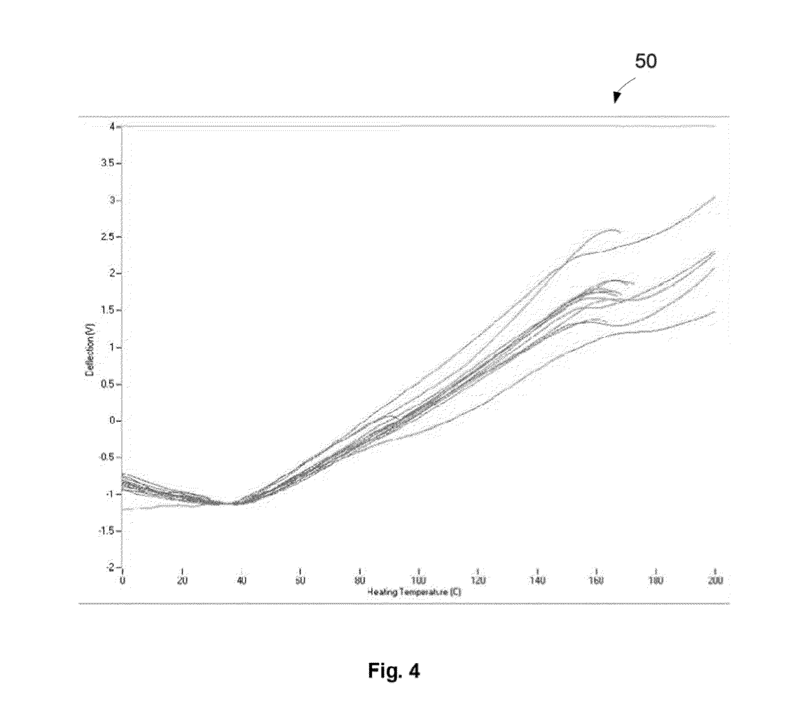

FIG. 4 shows a chart 50 illustrating the thermal property over the measured locations on the cross section of a straight bar arm of a polymeric stent. Compared against the results of FIG. 2, less abnormal thermal transitions appear along the straight bar than the curved or angled bar of the polymeric stent. By analyzing these transitions, the heat affected zone along a straight bar area can be as less as 5 μm.

Based on these results, NTA can be an effective method for detection and characterization of heat affected zones induced by laser ablation on a polymeric micro-sized device. Moreover, this data may be utilized to guide design of the device in such a manner to reduce thermal effects due to geometry. Furthermore, the information can be utilized to optimize the laser processing parameters to achieve the lowest possible thermal damage to the material.

The applications of the disclosed invention discussed above are not limited to certain processes, treatments, or placement in certain regions of the body, but may include any number of other processes, treatments, and areas of the body. Modification of the above-described methods and devices for carrying out the invention, and variations of aspects of the invention that are obvious to those of skill in the arts are intended to be within the scope of this disclosure. Moreover, various combinations of aspects between examples are also contemplated and are considered to be within the scope of this disclosure as well.

What is claimed is:

1. A method for characterizing mechanical properties of a polymeric stent, comprising:
detecting a position of a probe along the polymeric stent via atomic force microscopy;
applying heat through the probe to the polymeric stein at the position;
measuring a thermal-mechanical response via the probe.

2. The method of claim 1 further comprising measuring the thermal-mechanical response via the probe at a plurality of positions along the polymeric stent.

3. A method of characterizing thermal effects on a polymeric stent, comprising:
cutting one or more locations along a polymeric stent via a laser;
detecting a position of a probe along the polymeric stent via atomic force microscopy;
applying heat through the probe to the polymeric stent at the position;
measuring a thermal-mechanical response via the probe.

4. The method of claim 3 further comprising measuring the thermal-mechanical response via the probe at a plurality of positions along the polymeric stent.
